(19) United States
(12) Patent Application Publication
(10) Pub. No.: US 2015/0337125 A1
(43) Pub. Date: Nov. 26, 2015

(54) Brominated Flame Retardants and their use in Thermoplastic and Thermosetting Flammable Materials

(71) Applicant: Albemarle Corporation, Baton Rouge, LA (US)

(72) Inventors: Jonathan McCarney, Baton Rouge, LA (US); Jon Shannon Reed, Baton Rouge, LA (US); Daniel De Schryver, Bonheiden (BE); Govindarajulu Kumar, Baton Rouge, LA (US)

(73) Assignee: Albemarle Corporation, Baton Roube, LA (US)

(21) Appl. No.: 14/286,272

(22) Filed: May 23, 2014

(51) Int. Cl. C08L 27/10; C08L 23/14; C08L 77/06; B29C 47/00; D01F 6/06; D01F 6/08; D01F 6/60; C08L 63/04; C08L 31/04; C08L 67/02

(52) U.S. Cl. CPC C08L 27/10; C08L 31/04; C08L 23/14; C08L 77/06; C08L 67/02; D01F 6/06; D01F 6/08; D01F 6/60; C08L 63/04; B29C 47/0004; D10B 2401/041; C08L 2201/02; B29K 2085/00

(57) ABSTRACT

This invention relates to useful brominated flame retardants and the use of the brominated materials as flame retardants in flammable thermoplastic and thermosetting materials.

### TECHNICAL FIELD

This invention relates to useful brominated flame retardants and the use of the brominated materials as flame retardants in flammable thermoplastic and thermosetting materials.

### BACKGROUND

Much research has been conducted over the years in the search for new brominated flame retardants having superior properties, and such research has included a variety of very low molecular weight (number average degree of polymerization (DP)<21) oligostyrene materials, none of which has achieved commercial success. This invention provides a robust toluene styrenic oligomer distributions having a number average DP<6.5 with molecular weight distributions that are narrowly distributed with limited skewness and low asymmetry which distributions afford on bromination, the unique superior brominated flame retardants of this invention. Moreover, these brominated styrenic oligomeric distributions are particular useful for flame retardants for thermoplastic and thermosetting materials and can be produced on an economically attractive and industrially feasible commercial scale.

### SUMMARY OF THIS INVENTION

This invention relates to a brominated aromatic polymer composition has the formula:

C₆H₍₅₋ₓ₎BrₓCH₂CH₂(C₆H₍₅₋ₓ₎BrₓCHCH₂—)ₙCH₂C₆H₍₅₋ₓ₎Brₓ (I)

where C₆H₍₅₋ₓ₎Brₓ is a brominated phenyl group, n is an average number in the range of about 2.6 to about 5.5 for the brominated aromatic polymer composition, each x is the same or different and is a whole number in the range of 2 to 5, the average number of all of the x's is about 3 to 3.8 and wherein the weight percent of bromine as determined by XRF in the polymer is in the range of about 71 to about 75.

### DETAILED DESCRIPTION OF THIS INVENTION

Brominated Aromatic Polymer Composition

This invention relates to a brominated aromatic polymer composition having the formula:

C₆H₍₅₋ₓ₎BrₓCH₂CH₂(C₆H₍₅₋ₓ₎BrₓCHCH₂—)ₙCH₂C₆H₍₅₋ₓ₎Brₓ (I)

where C₆H₍₅₋ₓ₎Brₓ is a brominated phenyl group, n is an average number in the range of about 2.6 to about 5.5 for the brominated aromatic polymer composition, each x is the same or different and is a whole number in the range of 2 to 5, the average number of all of the x's is about 3 to 3.8 and wherein the weight percent of bromine as determined by XRF in the polymer is in the range of about 71 to about 75. In another embodiment, n is an average number in the range of about 2.9 to about 4.4, each x is the same or different and is a whole number in the range of 3 to 5, the average number of all of the x's in the brominated aromatic polymer composition being in the range of about 3.50 to about 3.80 and the weight percent of bromine as determined by XRF in the brominated aromatic polymer composition is in the range of about 73.4 to about 74.5.

In another embodiment, the brominated aromatic polymer composition of Formula I has a distribution characterized by having an Mₙ in the range of about 1610 to about 4320 or about 2440 to about 2950, an M_{b} in the range of about 1310 to about 3020 or about 1880 to about 2360, an M_{z} in the range of about 2060 to about 6670, or about 3120 to about 4400 and a polydispersity in the range of about 1.1 to about 1.65 or about 1.2 to about 1.35.

A structural representation of the brominated polymer composition is shown below.

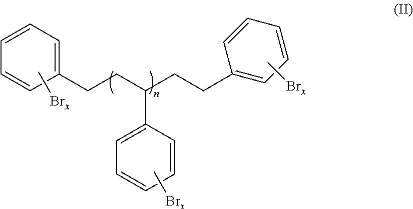

Again, n is an average number in the range of about 2.6 to about 5.5, or about 2.9 to about 4.4 (which when rounded off to whole numbers, becomes an average number in the range of about 3 to about 5), wherein each x is the same or different and is a whole number in the range of about 2 to about 5 or about 3 to about 5, the average number of all of the x's in the brominated aromatic polymer composition being in the range of about 3.00 to about 3.80 or about 3.50 to about 3.80 and the weight percent of bromine as determined by X-Ray Fluorescence Spectroscopy (XRF) in the brominated aromatic polymer composition being in the range of about 71 to about 75 or about 73.4 to about 74.5.

The brominated aromatic polymer composition of the present invention is known in the art and can be made according to the disclosure in WO 2010/065468, herein incorporated by reference in its entirety.

It is to be noted that formulas above concerning the brominated aromatic polymer composition are not intended to limit or otherwise specify the spatial configuration with regard to stereoregularity of the polymers. For example, the formula does not limit such polymers to any degree of tacticity such as primarily isotactic, primarily syndiotactic, or primarily atactic polystyrenes. It is also to be understood and appreciated that the term “polymer” as used anywhere herein, including the claims, refers to the term “polymer” as defined in the context of the OECD definition of “polymer”, which is as follows:
“A chemical substance consisting of molecules characterized by the sequence of one or more types of monomer units and comprising a simple weight majority of molecules containing at least three monomer units which are covalently bound to at least one other monomer unit or other reactant and which consists of less than a simple weight majority of molecules of the same molecular weight. Such molecules must be distributed over a range of molecular weights wherein differences in the molecular weight are primarily attributable to differences in the number of monomer units.”

### DEFINITIONS

| Parameter | Equation |
|---|---|
| DPₙ, Number average degree of | DPₙ = (Mₙ − MW_{CTA})/104 |
| polymerization | |
| Mₙ, Number average molecular | Mₙ = (Σ Mᵢnᵢ) |
| weight | |
| M_{w}, Weight average molecular | M_{w} = [(Σ Mᵢ²nᵢ)/Mₙ] |
| weight | |
| M_{z}, z-Average molecular weight | M_{z} = (Σ Mᵢ³nᵢ)/ΣMᵢ²nᵢ |
| PD, Polydispersity Index (also PDI) | PD = (Σ Mᵢnᵢ)/[(Σ Mᵢ²nᵢ)/Mₙ] |

Use of the Brominated Flame Retardants of this Invention

The brominated aromatic polymer composition of this invention (often referred to herein as “brominated flame retardants of this invention”) is characterized, among other things, by being broad spectrum flame retardants. This means that the flame retardants can be effectively used in a wide variety of different types of polymers, including various thermoplastic polymers. Additionally, the brominated flame retardants of this invention are deemed to be effective in thermoset polymers, such as epoxy resins used for printed wiring and circuit boards, as well as natural and synthetic elastomers, including thermoplastic polyurethane elastomers (TPU), etc.

Illustrative polymers in which the brominated flame retardants of this invention may be used include: olefin polymers, cross-linked and otherwise, for example homopolymers of ethylene, propylene, and butylene; copolymers of two or more of such alkene monomers and copolymers of one or more of such alkene monomers and other copolymerizable monomers, for example, ethylene/propylene copolymers, ethylene/ethyl acrylate copolymers and ethylene/propylene copolymers, ethylene/acrylate copolymers and ethylene/vinyl acetate copolymers; polymers of olefinically unsaturated monomers, for example, polystyrene, e.g. high impact polystyrene, and styrene copolymers, polyurethanes; polyamides; polyimides; polycarbonates; polyethers; acrylic resins; polyesters, especially poly(ethyleneterephthalate) and poly(butyleneterephthalate); polyvinyl chloride; thermosets, for example, epoxy resins; elastomers, for example, butadiene/styrene copolymers and butadiene/acrylonitrile copolymers; terpolymers of acrylonitrile, butadiene and styrene; natural rubber; butyl rubber and polysiloxanes. The polymer may be, where appropriate, cross-linked by chemical means or by irradiation. The brominated flame retardants of this invention can also be used in textile applications, such as in latex-based back coatings.

The amount of brominated flame retardants of this invention used in a formulation will be that quantity needed to obtain the flame retardancy sought. In general, the formulation and resultant product may contain from about 1 to about 30 wt %, preferably from about 5 to about 25 wt % of a brominated flame retardant of this invention. Master batches of polymer containing a brominated flame retardant of this invention, which are blended with additional amounts of substrate polymer or binding agent, typically contain even higher concentrations of the flame retardant, e.g., up to 95 wt % or more.

### Metal Synergists

Typically, polymer compositions containing the brominated aromatic polymer composition (i.e., a brominated flame retardant) are used with flame retarding metal synergist. The metal synergists are well known in the art and examples of such synergists are iron oxide, zinc borate, or, preferably, antimony oxide synergists, such as, antimony trioxide, antimony pentoxide, potassium antimonate or sodium antimonate. Antimony trioxide is the most commonly used flame retardant synergist and generally will be in the range of up to about 12 wt % based on the total weight of the polymer composition. Synergist amounts will most often fall within the range of from greater than 1 wt % to about 6 wt %. Generally, the brominated flame retardant will be used with the synergists in a weight ratio ranging from about 1:1 to 7:1, and preferably of from about 2:1 to about 4:1.

### Anti-Drip Agents

The polymer compositions of the present application may contain an anti-drip agent. Although various materials are available for the use of anti-drip agents, preferred materials include fluoropolymers and ethylene/methacrylic acid (E/MAA) copolymers in which the MAA groups have been partly neutralized with sodium or zinc ions to make sodium or zinc salts of the E/MAA copolymers. Materials of this type are available commercially and include fluoropolymers such as polytetrafluoroethylene (PTFE) or related materials available from DuPont under the TEFLON® trademark (e.g., TEFLON T807N, and TEFLON 6C-N), and Ethylene/methacrylic acid copolymers (“ionomers”) available from DuPont under the SURLYN® trademark such as SURLYN 8920, PC100 or 1706 polymer. Combinations or mixtures of fluoropolymers and ionomers are/can be advantageous.

In one embodiment, polymer compositions of the present invention are those which contain one or more of the following distinguishing characteristics:
a TGA weight loss of 5% occurring at a temperature greater than 350° C.,
a thermal HBr value at 300° C. below the detection limit of 50 ppm and no more than about 200 ppm,
a thermal HBr value at 320° C. in the range of about 100 ppm to about 900 ppm,
an ASTM D 1925 Yellowness Index in the range of about 1 to about 4,
a ΔE value in the Hunter Solution Color Value Test in the range of 0 to about 1, and
a glass transition temperature in the range of about 111° C. to about 125° C.

### Analytical Methods

Known analytical methods can be used or adapted for use in assaying the characteristics of the compositions and formulations of this invention.

### Total Bromine Content

Since the compositions of this invention have good, or at least satisfactory, solubility in solvents such as tetrahydrofuran (THF), the determination of the total bromine content for the compositions of this invention is easily accomplished by using conventional X-Ray Fluorescence techniques. The sample analyzed is a dilute sample, say 0.1 g+/−0.05 g in 60 mL THF. The XRF spectrometer can be a Phillips PW1480 Spectrometer. A standardized solution of bromobenzene in THF is used as the calibration standard. The total bromine values described herein and reported in the Examples are all based on the XRF analytical method.

### Hunter Solution Color Value Test

To determine the color attributes of the flame retardant compositions of this invention, use is again made of the ability to dissolve these compositions in easy-to-obtain solvents, such as chlorobenzene. The analytical method entails weighing a 5 gram+/−0.1 g sample of the composition into a 50 mL centrifuge tube. To the tube also add 45 g+/−0.1 g chlorobenzene. Close the tube and shake for 1 hour on a wrist action shaker. After the 1 hour shaking period, examine the solution for undissolved solids. If a haze is present, centrifuge the solution for 10 minutes at 4000 rpm. If the solution is still not clear, centrifuge an additional 10 minutes. Should the solution remain hazy, then it should be discarded as being incapable of accurate measurement. If, however, and this is the case most of the time, a clear solution is obtained, it is submitted for testing in a HunterLab Color Quest Sphere Spectrocolorimeter. A transmission cell having a 20-mm transmission length is used. The colorimeter is set to “Delta E-lab” to report color as ΔE and to give color values for “L”, “a” and “b”. Product color is determined as total color difference (ΔE) using Hunter L, a, and b scales for the 10% by weight concentrations of the product in chlorobenzene versus chlorobenzene.

### Yellowness Index Hunter Colorimeter

Compositions of this invention were subjected to the analysis described in ASTM D 1925

### T_{g}Values

T_{g} values were obtained by DSC with a TA Instruments DSC Model 2920. Samples were heated to 400° C. at a rate of 10° C./min under nitrogen. T_{g} is determined by noting the change in the specific heat of a polymer at the glass to rubber transition. This is a second order endothermic transition (requires heat to go through the transition). In DSC, the transition appears as a step transition and not a peak such as might be seen with a melting transition. See, The Elements of Polymer Science and Engineering, An introductory Text for Engineers and Chemist, Alfred Rudin, Academic Press, Orlando Fla., 1982, pg 403.

### Thermogravimetric Analysis.

Thermogravimetric analysis (TGA) is also used to test the thermal behavior of the flame retardant compositions of this invention. The TGA values are obtained by use of a TA Instruments Thermogravimetric Analyzer. Each sample is heated on a Pt pan from 25° C. to about 600° C. at 10° C./min with a nitrogen flow of 50-60 mL/min.

### GPC Molecular Weights for Brominated Stripped Styrene Polymer Distribution

The M_{w}, Mₙ, M_{Z} and PD values were obtained by gel permeation chromatography (GPC) using an integrated multidetector GPC system manufactured by Viscotek Corporation. The system includes a combination pump and autosampler (model GPC-Max) along with an integrated detector system (model TDA) which includes a refractive index detector (RI) along with a dual angle light scattering detector. The columns used were Polymer Labs (Varian) Oligopore columns, 300 mm by 7.5 mm, part number 1113-6520. The solvent used was tetrahydrofuran, HPLC grade. The test procedure entails dissolving approximately 0.20 g of sample in 10 mL of THF. An aliquot of this solution is filtered and 50 μL is injected on the columns. Light scattering determinations require a single polystyrene standard for calibration. A polystyrene standard with a known molecular weight of 19,550 Daltons was used to calibrate the detector system. The software used to determine the molecular weight distribution was Viscotek Omnisec, version 4.2.0.237 gel permeation chromatography (GPC) data collection and processing system.

### Blending Procedures

Various known procedures can be used to prepare the blends or formulations constituting the compositions of this invention. For example the polymers and anti-drip components are preferably compounded using a mixer or an extruder. For example, apparatuses that may be used are continuous single or twin screw mixers like a Farrel continuous mixer, a Werner and Pfleiderer twin screw extruder, or a Buss kneading continuous extruder. Batch apparatuses may be also be used such as internal batch mixers like a Banbury or Bolling internal mixer. The type of mixer or extruder utilized, and the operating conditions of the mixer or extruder, will affect properties of the composition such as viscosity, volume resistivity, and extruded surface smoothness. The extrudate from the extruder is typically converted into granules or pellets either by water cooling strands of the extruding polymer and subdividing the solidified strands into granules or pellets, or by subjecting the extrudate to concurrent die-faced pelletizing and water-cooling or air-cooling. The use of die-faced pelletizing is especially suitable when the thermoplastic polyester or polyamide is highly filled, e.g., as a masterbatch or concentrate. If desired the additive compositions of this invention can be formulated as powder or granular blends of the additive components. Alternatively, the components can be melt blended together, with the inclusion, where necessary or appropriate, of some of the substrate polyester or nylon polymer in which the additive composition is to be blended.

### Polymer Processing

The compounded polymers of this invention can be processed in conventional ways. For example, the compounds can be transformed into the final articles by appropriate processing techniques such as injection molding, compression molding, extrusion, or like procedures.

A particularly preferred use of the polymer composition of the present invention is fibers and filaments. In the fibers and filaments, the brominated aromatic polymer composition is generally at least about 2 wt % of the fiber or filament. Typically, the brominated aromatic polymer composition is within the range of from about 5 to about 20 wt %, the wt % being based on the total weight of the fiber or filament. Other ingredients may also be present in the fiber or filament. In particular, flame retardant synergists (e.g., antimony trioxide) are often used. The amount of flame retardant synergist, when used, generally will be in the range of up to about 12 wt % based on the total weight of the finished fiber or filament. Departures from the foregoing ranges of proportions are permissible whenever deemed necessary or desirable under the particular circumstances at hand, and such departures are within the scope and contemplation of this invention. It will be appreciated that the optimum amount of brominated aromatic polymer composition varies with the particular fiber-forming polymer, the weight of the cloth to be produced, any other ingredients present, and the flammability test to be passed.

One method for forming fibers or filaments is a process which comprises conventional melt spinning (a) at least one fiber-forming thermoplastic polymer, and (b) the brominated aromatic polymer composition. One skilled in the art of fiber or filaments melt spinning would be able to produce the fiber or filaments using conventional melt spinning techniques.

### EXAMPLES

In the Examples BFR means the Brominated Flame retardant produced in Example 1.

### Example 1

### Part A

Toluene 140 pounds, (689 mol) was charged to the reactor; Karl Fischer moisture analysis indicated 7 ppm residual H2O. Agitation began. The solvent was heated to 78° C. by applying tempered water to the vessel jacket. Upon reaching the set point temperature, 4.07 pounds of N,N,N′,N′-Tetramethylethylenediamine (TMEDA, 15.9 mol) in 10 pounds of toluene (49.24 mol) was charged to the reactor through the dip leg below the surface of the agitated toluene reaction mixture. The feed line was then flushed with 21 pounds (103 mol) of anhydrous toluene. Next, 3.9 lb n-BuLi solution (23.5 wt % in cyclohexane) (6.53 mol n-BuLi) was charged through the subsurface feed line forming the characteristic bright red-orange color of TMEDA complexed benzyl lithium anion with concomitant off gassing of butane. The feed line was then flushed with 21 pounds (103 mol) of anhydrous toluene.

Styrene (374.4 lb, 99+%, 1629 mol, American Styrenics) was fed over 162 minutes. The styrene was added by means of pressure transfer from a nitrogen regulated portable tank through a metering valve at a constant feed rate of 2.31 lb/min. The reactor was allowed to ride for 5 minutes to make certain the reaction was complete.

The reaction mixture was quenched at 70° C. with 10 gallons of 0.75 wt % ammonium chloride solution which had been deoxygenated overnight by sparging with nitrogen gas. The reaction mixture was washed with a second 10 gallons of deoxygenated water. Phase cuts were rapid and required little settling time. Water and any rag or emulsion was removed through the bottom drain valve.

The reactor was heated to atmospheric boiling point using tempered water on the vessel jacket. Steam was then applied to the reactor jacket to increase the temperature of the reactor jacket to 140° C. Cyclohexane, residual moisture and toluene boiled, condensed in the overhead condenser, and drained to a drum until a pot temperature of 135° C. was observed.

The reactor was cooled to 50° C. Vacuum was applied to the vessel and the reactor was heated to boiling point. Steam was then applied to the reactor jacket to increase the temperature of the reactor jacket to 140° C. Vacuum was used to decrease the reactor pressure to 35 mm Hg. Cyclohexane, residual moisture and toluene boiled, condensed in the overhead condenser, and drained to a drum until a pot temperature of 135° C. was observed. An aliquot was removed from the reactor for analysis via GPC (Mn: 433, Mw: 626, Mz: 883, polydispersity (PD): 1.45). The reaction mass (443 lbs.) was collected in a 350-gallon tote bin.

### Example 1

### Part B

A 3893 g sample of the crude plant-stripped reaction mixture (SPD1, prepared in Example 1-Part A) was stripped using a wiped film evaporator (WFE) manufactured by Pope Scientific Inc. to remove residual toluene and 1,3-diphenylpropane (to 1.0 GPC area % max specification) to yield 3111 g of SSPD1 that had the following GPC analysis: Mn: 543, Mw: 698, Mz: 907, PD: 1.29. WFE operating conditions were as follows: feed rate=1.33 L/hr, oil jacket temperature=155° C., Pressure=<0.1 mmHg and condenser temperature=0° C. Additionally the cold finger condensed 784 g of a mixture of toluene, 1,3-diphenylpropane and 1,3,5-triphenylpentane.

### Examples 2-5

The following Examples 2-5 are presented for the purposes of illustration and are not to be taken as limitations on the scope of the invention. In these Examples, ethylene vinyl acetate (EVA) (Elvax 460; DuPont) was compounded with the specified additive components in the amounts specified using a Werner & Pfleiderer ZSK 25 twin-screw extruder. In the table below, Vul-CUP® 40KE is a a,a′-bis(tert-butylperoxy)diisopropylbenzene peroxide from Arkema Inc., Burgess KE is a silane modified anhydrous aluminum silicate clay from the Burgess Pigment Company, Saytex®8010 is Ethane-1,2-bis(pentabrmomo phenyl) flame retardant, Saytex® 102E is decabromodiphenyl oxide and Saytex BT-93 is ethylenebistetrabromophthalimide, all from Albemarle Corporation. Test pieces were formed on a Boy 30A Injection Molding machine at barrel and nozzle temperatures no higher than 220° C. prefer between 120° and 200° C. and a mold temperature of no higher than 50° C. preferably around 10° C. All loading in the Examples are by wt %. These blends were molded into test pieces which were then subjected to a variety of standard test procedures.

TABLE 1
EVA Formulations and Test results

| | Examples | | | |
|---|---|---|---|---|
| | | 3 | 4 | 5 |
| | 2 | Saytex | Saytex | Saytex |
| | BFR | 102E | 8010 | BT-93 |
| Ingredient | | | | |
| Elvax 460 (wt %) | 50 | 50 | 50 | 50 |
| Antimony Trioxide (wt %) | 7 | 7 | 7 | 7 |
| Burgess KE Clay (wt %) | 19 | 19 | 19 | 19 |
| FR Loading (wt %) | 21 | 21 | 21 | 21 |
| Vulcup 40KE (wt %) | 3 | 3 | 3 | 3 |
| Specific Gravity | 1.37 | 1.41 | 1.41 | 1.39 |
| UL 94, ⅛ in | V0 | V0 | V0 | V0 |
| UL 94, T1 + T2 time, sec | 7.3 | 7.4 | 7.6 | 7.0 |
| Tensile Strength, MPa | 14.0 | 14.4 | 14.8 | 14.5 |
| Ultimate Elongation, % | 200 | 205 | 199 | 173 |
| Dielectric Constant | 2.89 | 2.98 | 2.89 | 3.07 |
| Dielectric Strength, kV/mm | 20.1 | 20.0 | 21.5 | 21.0 |
| Volume Resistivity, Ohm-cm, | 6.12 | 2.15 | 5.85 | 11.00 |
| 10E14 | | | | |

### Examples 6-9

The following Examples 6-9 are presented for the purposes of illustration and are not to be taken as limitations on the scope of the invention. In these Examples, an impact polypropylene copolymer (Pro-Fax 7523; Lyondell Basel) was compounded similar to Examples 2-5. In the table below, Engage® 7256 is an ethylene-butylene copolymer from Dow Corp., and Minstron Vapor Talc is a high surface area talc from Imerys Talc, Irganox® is a Pentaerythritol Tetrakis(3-(3,5-di-tert-butyl-4-hydroxyphenyl)propionate) antioxidant from BASF Corp and Irgaphos 168 is Tris (2,4-di-tert-butylphenyl)phosphite antioxidant from BASF.

TABLE 2
Thermoplastic Elastomer (TPE) Formulations and Results

| | | Examples | | | |
|---|---|---|---|---|---|
| | | | 7 | 8 | 9 |
| | | 6 | aytex | Saytex | Saytex |
| | | BFR | 102E | 8010 | BT-93 |
| Ingredient | | | | | |
| Profax ® 7523 (wt %) | | 45.4 | 45.4 | 45.4 | 45.4 |
| Engage ® 7256 (wt %) | | 11.4 | 11.4 | 11.4 | 11.4 |
| FR Loading (wt %) | | 22.0 | 22.0 | 22.0 | 22.0 |
| Antimony Trioxide (wt %) | | 7.0 | 7.0 | 7.0 | 7.0 |
| Mistron ® Vapor Talc (wt %) | | 14.0 | 14.0 | 14.0 | 14.0 |
| Irganox 1010 (wt %) | | 0.1 | 0.1 | 0.1 | 0.1 |
| Irgafos 168 (wt %) | | 0.1 | 0.1 | 0.1 | 0.1 |
| Mechanical | | | | | |
| Properties | | | | | |
| Specific Gravity | | 1.24 | 1.28 | 1.26 | 1.24 |
| Tensile Strength | MPa | 22.8 | 21.4 | 20.7 | 22.8 |
| Elongation @ | % | 3.0 | 5.5 | 5.8 | 5.6 |
| Yield | | | | | |
| Elongation @ | % | 67 | 113 | 360 | 14 |
| Break | | | | | |
| Flexural Strength | MPa | 40.7 | 38.0 | 39.3 | 40.0 |
| Flexural Modulus | MPa | 2415 | 1794 | 1518 | 1794 |
| Izod Impact | J/cm | 0.29 | 0.33 | 0.40 | 0.28 |
| GLOSS | | 24.6 | 16.5 | 19.4 | 21.4 |
| Thermal | | | | | |
| Properties | | | | | |
| Melt Flow Index | g/10 min | 6.7 | 3.7 | 3.7 | 3.2 |
| HDT | ° C. | 104.5 | 102.7 | 99.6 | 102.6 |
| VICAT | ° C. | 148.2 | 154.2 | 154.3 | 153.9 |
| Electrical | | | | | |
| Properties | | | | | |
| Dielectric | | 2.46 | 2.48 | 2.49 | 2.49 |
| Constant | | | | | |
| Volume | Ohm-cm | 1.6 | 0.8 | 0.8 | 1.2 |
| Resistivity | 10E16 | | | | |
| Surface | Ohm-cm | 5.9 | 3.4 | 2.6 | 5.1 |
| Resistivity | 10E16 | | | | |
| Dielectric | kV/mm | 25.1 | 20.7 | 20.7 | 21.7 |
| Strength | | | | | |

### Examples 10-13

The following Examples 10-13 are presented for the purposes of illustration and are not to be taken as limitations on the scope of the invention. In these Examples, an impact polypropylene copolymer (Pro-Fax 7523; Lyondell Basel) was compounded similar to Examples 6-9.

TABLE 3
Polypropylene Formulations and Results

| | | Examples | | | |
|---|---|---|---|---|---|
| | | | 11 | 12 | 13 |
| | | 10 | Saytex | Saytex | Saytex |
| | | BFR | 102E | 8010 | BT-93 |
| Ingredient | | | | | |
| Profax 7523 (wt %) | | 56.8 | 56.8 | 56.8 | 56.8 |
| BFR Loading (wt %) | | 22.0 | 22.0 | 22.0 | 22.0 |
| Antimony Trioxide (wt %) | | 7.0 | 7.0 | 7.0 | 7.0 |
| Mistron Vapor Talc (wt %) | | 14.0 | 14.0 | 14.0 | 14.0 |
| Irganox 1010 (wt %) | | 0.1 | 0.1 | 0.1 | 0.1 |
| Irgafos 168 (wt %) | | 0.1 | 0.1 | 0.1 | 0.1 |
| Mechanical | | | | | |
| Properties | | | | | |
| Specific | | 1.25 | 1.27 | 1.27 | 1.26 |
| Gravity | | | | | |
| Tensile | MPa | 18.6 | 17.3 | 15.9 | 19.3 |
| Strength | | | | | |
| Tensile | MPa | 3103 | 3036 | 2896 | 3034 |
| Modulus | | | | | |
| Elongation @ | % | 2.3 | 3.3 | 3.2 | 2.3 |
| Yield | | | | | |
| Elongation @ | % | 7.5 | 30.6 | 25.5 | 8.7 |
| Break | | | | | |
| Flexural | MPa | 45.5 | 43.5 | 42.8 | 45.5 |
| Strength | | | | | |
| Flexural | MPa | 2413 | 2277 | 2277 | 2206 |
| Modulus | | | | | |
| Izod Impact | J/cm | 0.22 | 0.28 | 0.27 | 0.20 |
| GLOSS | | 27.8 | 21.3 | 25.1 | 24.4 |
| Thermal | | | | | |
| Properties | | | | | |
| Melt Flow | g/10 min | 6.2 | 4.0 | 3.9 | 3.4 |
| Index | | | | | |
| HDT | ° C. | 115.3 | 119.5 | 120.8 | 118.7 |
| VICAT | ° C. | 148.2 | 154.2 | 154.3 | 153.9 |
| Electrical | | | | | |
| Properties | | | | | |
| Dielectric | | 2.49 | 2.51 | 2.49 | 2.55 |
| Constant | | | | | |
| Dissipation | % | 3.60 | 1.47 | 1.81 | 1.84 |
| Factor | | | | | |
| Volume | Ohm-cm | 1.5 | 1.0 | 1.4 | 1.5 |
| Resistivity | 10E16 | | | | |
| Surface | Ohm-cm | 6.4 | 3.8 | 4.6 | 10.2 |
| Resistivity | 10E16 | | | | |
| Dielectric | kV/mm | 25.5 | 21.0 | 21.0 | 22.1 |
| Strength | | | | | |

### Examples 14-16

The following Examples 14-16 are presented for the purposes of illustration and are not to be taken as limitations on the scope of the invention. In these Examples, an Polyamide 66 Nylon resin (Zytel® 70G43L; Dupont) was compounded similar to Examples 2-5 except that the temperatures of the extruder and injection molding machine ranged from 270° to 305° C. with a mold temperature between 50° and 90° C. preferably around 70° C. All loading are by wt %. The formulation contained 30 wt % glass fibers. In the Table below, PTFE 6C is a polytetrafluoroethylene resin from Dupont.

TABLE 4
30% Glass Fiber (GF) Polyamide 6/6 Formulations

| | | Examples | | |
|---|---|---|---|---|
| | | 14 | 15 | 16 |
| | Units | BFR | Saytex HP-3010 | Saytex HP-7010 |
| Ingredient | | | | |
| Zytel 70G43L | | 74% | 68% | 68% |
| (Wt %) | | | | |
| BFR Loading | | 19.0 | 20.7 | 20.7 |
| (Wt %) | | | | |
| Antimony | | 6.3 | 6.3 | 6.3 |
| Trioxide (Wt %) | | | | |
| PTFE Teflon ® | | 0.4 | 0.4 | 0.4 |
| 6C (Wt %) | | | | |
| Flammability | | | | |
| LOI | % | 36.8 | 36.4 | 36.1 |
| | Oxygen | | | |
| UL-94 1/32″ | Rating | V-0 | V-0 | V-0 |
| | sec | 7 | 20 | 26 |
| Physical | | | | |
| Properties | | | | |
| Specific Gravity | | 1.63 | 1.65 | 1.62 |
| Gloss | N/A | 29.2 | 22.6 | 20.3 |
| Initial Color | YI | 20.9 | 15.8 | 18.9 |
| | (D1925) | | | |

### Examples 17-20

The following Examples 17-20 are presented for the purposes of illustration and are not to be taken as limitations on the scope of the invention. In these Examples, polybutylene terephthalate polyester thermoplastic resins (Crastin®; Dupont) was compounded similar to Examples 2-5 except that the temperatures of the extruder and injection molding machine ranged from 240° to 260° C. with a mold temperature between 60° and 100° C. preferably around 80° C. All loadings are by wt %. The formulation contained 30 wt % glass fibers. In the Table below, Saytex 620 is a physical blend of brominated polystyrene and a polyester resin from Albemarle Corporation.

TABLE 5
30% GF PBT Formulations

| | | Examples | | | |
|---|---|---|---|---|---|
| | | | 18 | 19 | 20 |
| | | 17 | Saytex | Saytex | Saytex |
| | Units | BFR | PBT620 | 8010 | BT-93 |
| Ingredients | | | | | |
| % Br in Flame retardant | | 74% | 54% | 82% | 67% |
| Crastin 6134 PBT w/45% | | 66.6 | 66.6 | 66.6 | 66.6 |
| fiber glass | | | | | |
| Crastin 6134 PBT (wt %) | | 17 | 13 | 18 | 16 |
| FR Loading (wt %) | | 11.0 | 15.0 | 10.0 | 12.0 |
| Antimony Trioxide | | 5.0 | 5.0 | 5.0 | 5.0 |
| (wt %) | | | | | |
| PTFE Teflon 6C (wt %) | | 0.4 | 0.4 | 0.4 | 0.4 |
| Flammability | | | | | |
| LOI | % | 33.1 | 31.8 | 33.5 | 32.9 |
| | Oxygen | | | | |
| UL-94 1/32″ | Pass/Fail | V-0 | V-0 | V-0 | V-0 |
| | seconds | 7 | 8 | 8 | 8 |
| Physical | | | | | |
| Properties | | | | | |
| Specific | | 1.68 | 1.67 | 1.70 | 1.73 |
| Gravity | | | | | |
| Gloss | n/a | 29.1 | 14.3 | 14.7 | 15.2 |
| Initial Color | YI | 14.80 | 11.40 | 13.37 | 21.35 |

### Examples 21-24

The following Examples 21-24 are presented for the purposes of illustration and are not to be taken as limitations on the scope of the invention. In these Examples, polyethylene terephthalate polyester thermoplastic resins (Rynite®; Dupont) was compounded similar to Examples 2-5 except that the temperatures of the extruder and injection molding machine ranged from 260° to 300° C. with a mold temperature between 80° and 120° C. All loading are by wt %. The formulation contained 30 wt % glass fibers. In the Table below, Saytex 120 is tetradecabromodiphenoxybenzene from Albemarle Corporation.

TABLE 6
30% GF PET Formulations

| | | Examples | | | |
|---|---|---|---|---|---|
| | | | 22 | 23 | 24 |
| | | 21 | Saytex | Saytex | Saytex |
| | | BFR | 3010 | 7010 | 120 |
| Ingredient | | | | | |
| Rynite 545 (wt %) | | 33 | 34 | 34 | 31 |
| Rynite 530 (wt %) | | 50.6 | 48.6 | 48.6 | 53.6 |
| FR Loading | | 11 | 12 | 12 | 10 |
| (wt %) | | | | | |
| Antimony | | 5 | 5 | 5 | 5 |
| Pentoxide (wt %) | | | | | |
| PTFE Teflon 6C | | 0.4 | 0.4 | 0.4 | 0.4 |
| (wt %) | | | | | |
| LOI | % | 30.6 | 27.5 | 27.5 | 31 |
| | Oxygen | | | | |
| UL-94 | Pass/Fail | V-0 | V-0 | V-0 | V-0 |
| | seconds | 11 | 14 | 11 | 13 |

### Examples 25-43

The following Examples 25-43 are presented for the purposes of illustration and are not to be taken as limitations on the scope of the invention. In these Examples, polypropylene homopolymer (PPH 9069 from (Total Petrochemicals)) was compounded with Antimony trioxide (Campine Corp) and the flame retardant using a Werner & Pfleiderer ZSK 18 twin-screw extruder. Filament was made from these compounded materials using a pilot scale spinning line from Thermoalfa resulting in an average yarn thickness of about 29.6 μm/filament. Tensile Strength tests were performed according to ISO 2062 norm utilizing an Instron tensile strength tester. The results are shown in Table 7 below.

TABLE 7
Tensile strength test of polypropylene filaments

| | | tenacity | Strain | chord | Tenacity | Strain |
|---|---|---|---|---|---|---|
| | | at yield | at yield | modulus | at break | at break |
| Sample name | Ex | (N/tex) | (%) | (N/tex) | (N/tex) | (%) |
| 10% BFR | 25 | 0.22 | 51.85 | 1.68 | 0.221 | 79.625 |
| 7.5% BFR | 26 | 0.251 | 33.44 | 1.71 | 0.269 | 105.215 |
| 5% BFR | 27 | 0.266 | 33.42 | 1.82 | 0.287 | 111.417 |
| 10% BFR + 3% Sb2O3 | 28 | 0.25 | 45.93 | 1.7 | 0.255 | 84.259 |
| 7.5% BFR + 2.25% | 29 | 0.265 | 38.61 | 1.73 | 0.271 | 84.835 |
| Sb2O3 | | | | | | |
| 5% BFR + 1.5% Sb2O3 | 30 | 0.276 | 31.85 | 1.9 | 0.278 | 83.885 |
| 10% BFR + 2.5% Sb2O3 | 31 | 0.252 | 35.05 | 1.83 | 0.261 | 68.541 |
| 7.5% BFR + 1.88 Sb2O3 | 32 | 0.267 | 36.68 | 1.78 | 0.28 | 93.66 |
| 5% BFR + 1.25% Sb2O3 | 33 | 0.275 | 32.88 | 1.81 | 0.286 | 92.857 |
| 10% BFR + 2% Sb2O3 | 34 | 0.265 | 65.83 | 1.63 | 0.269 | 85.464 |
| 7.5% BFR + 1.5% Sb2O3 | 35 | 0.274 | 33.37 | 1.8 | 0.289 | 96.595 |
| 5% BFR + 1% Sb2O3 | 36 | 0.284 | 39.31 | 1.83 | 0.294 | 91.003 |
| 5% HP-3010 + 1.5% | 37 | 0.171 | 29.75 | 1.37 | 0.171 | 60.909 |
| Sb2O3 thick | | | | | | |
| 5% HP-3010 + 1.5% | 38 | 0.217 | 24.38 | 1.46 | 0.22 | 30.894 |
| Sb2O3 thin | | | | | | |
| 7.5% HP-3010 + 2.25% | 39 | 0.22 | 28.58 | 1.58 | 0.22 | 32.053 |
| Sb2O3 | | | | | | |
| 5% HP-3010 + 1.25% | 40 | 0.222 | 23.57 | 1.7 | 0.222 | 27.606 |
| Sb2O3 | | | | | | |
| 7.5% HP-3010 + 1.88 | 41 | 0.204 | 22.98 | 1.59 | 0.204 | 27.316 |
| Sb2O3 | | | | | | |
| 10% HP-3010 + 1% | 42 | 0.191 | 18.91 | 1.83 | 0.192 | 21.608 |
| Sb2O3 | | | | | | |
| 5% HP-3010 + 1% Sb2O3 | 43 | 0.282 | 25.98 | 2.28 | 0.282 | 32.692 |

### Examples 44-64

The following Examples 44-64 are presented for the purposes of illustration and are not to be taken as limitations on the scope of the invention. In these Examples, polyamide (PA 6 from Beaulieu International Group) was compounded with Antimony trioxide (Campine Corp) and the flame retardants using a Werner & Pfleiderer ZSK 18 twin-screw extruder. Filament was made from these compounded materials using a pilot scale spinning line from Thermoalfa resulting in an average yarn thickness of about 33.9 μm/filament. Tensile Strength tests were performed according to ISO 2062 norm utilizing an Instron tensile strength tester. The results are shown in Table 8 below.

TABLE 8
Tensile strength test of polyamide P6 filaments

| | | tenacity | Strain | chord | Tenacity | Strain |
|---|---|---|---|---|---|---|
| | | at yield | at yield | modulus | at break | at break |
| Sample | Ex | (N/tex) | (%) | (N/tex) | (N/tex) | (%) |
| 7.5% BFR | 44 | 0.313 | 57.9 | 1.37 | 0.317 | 65.1 |
| 5% BFR | 45 | 0.325 | 56.9 | 1.45 | 0.327 | 64.4 |
| 10% BFR | 46 | 0.294 | 56.3 | 1.41 | 0.296 | 64.7 |
| 7.5% BFR + 2.25% | 47 | 0.301 | 52.7 | 1.47 | 0.306 | 61.3 |
| Sb2O3 | | | | | | |
| 5% BFR + 1.5% Sb2O3 | 48 | 0.311 | 53.3 | 1.45 | 0.314 | 59.8 |
| 10% BFR + 3% Sb2O3 | 49 | 0.347 | 50.4 | 1.77 | 0.354 | 60 |
| 7.5% BFR + 1.5% Sb2O3 | 50 | 0.299 | 51.3 | 1.43 | 0.301 | 60.4 |
| 5% BFR + 1% Sb2O3 | 51 | 0.314 | 55.8 | 1.39 | 0.317 | 62.3 |
| 10% BFR + 2% Sb2O3 | 52 | 0.294 | 56.7 | 1.42 | 0.295 | 63 |
| 7.5% HP-3010 | 53 | 0.249 | 36.8 | 1.58 | 0.257 | 48.7 |
| 5% HP-3010 | 54 | 0.305 | 48.8 | 1.48 | 0.316 | 61.2 |
| 10% HP-3010 | 55 | 0.203 | 30.2 | 1.45 | 0.209 | 41.1 |
| 7.5% HP-3010 + 2.25% | 56 | 0.247 | 38.1 | 1.43 | 0.256 | 49.2 |
| Sb2O3 | | | | | | |
| 5% HP-3010 + 1.5% | 57 | 0.29 | 39.6 | 1.64 | 0.297 | 51.4 |
| Sb2O3 | | | | | | |
| 10% HP-3010 + 3% | 58 | 0.208 | 41 | 1.26 | 0.213 | 53.7 |
| Sb2O3 | | | | | | |
| 7.5% HP-3010 + 1.5% | 59 | 0.231 | 42.6 | 1.3 | 0.236 | 54.7 |
| Sb2O3 | | | | | | |
| 5% HP-3010 + 1% | 60 | 0.293 | 43.8 | 1.51 | 0.3 | 54.2 |
| Sb2O3 | | | | | | |
| 10% HP-3010 + 2% | 61 | 0.213 | 48.6 | 1.17 | 0.219 | 62.4 |
| Sb2O3 | | | | | | |
| 15% HP-3010 + 3% | 62 | 0.173 | 36.4 | 1.21 | 0.188 | 61.5 |
| Sb2O3 | | | | | | |
| 15% HP-3010 + 3% | 63 | 0.167 | 37.1 | 1.17 | 0.178 | 60.6 |
| Sb2O3 | | | | | | |
| 15% BFR + 3% Sb2O3 | 64 | 0.265 | 46.4 | 1.54 | 0.269 | 55.5 |

### Example 65

A stock solutions of advanced resin, curative and promoter are all prepared and stored separately to facilitate experimentation. An 85 wt % phenol epoxy novolac resin solution, DEN® 438-EK85, containing 15 wt % 2-butanone (MEK) was obtained from The Dow Chemical Company. Durite SD-1702 novolak curing agent was obtained from Hexion Corporation. A novolac resin solution was prepared by dissolving 50 wt % SD-1702 in 50 wt % MEK solvent. The BFR was jet-milled to an average particle size of 3.01 micron (d₅₀=2.64 micron). A flame retardant resin mixture containing 20.0 wt % Br was prepared in an 8 oz. wide-mouth glass jar by adding 75.76 g of 85 wt % DEN 438 solution, 75.60 g of 50 wt % SD-1702 solution and 38.20 g of the flame retardant. Toluene (95 g) was added to the resin mixture, and a solution was obtained by continuously mixing while heating the jar with a heat gun. Curing promoter, 2-phenylimidazole (0.052 g) was added and mixed well into the resin solution. The novolac-to-promoter ratio was about 742:1. About 0.5-1 mL of the resin solution was added to a hot cure plate (Thermo-electric company) at about 162-164° C. A tongue depressor was split in half lengthwise, and half of the depressor was used to move the resin on the hot plate until stiffness was noted and then lifting the resin with the flat part of the depressor until string formation ceased. The gel time was 4 minutes, 24 seconds, determined by the point where resin “strings” could no longer be pulled from the resin mixture and the epoxy becomes “tack free”.

An 11 inch square woven glass fabric (7628 glass with 643 finish from BGF Industries) was cut to size from a large roll and stapled to wood supports (12 inches long, 1 inch wide and 1/16 inch thick) on the top and bottom ends of the fabric. The wood supports contained holes in the corners for inserting paper clips on one end for hanging the fabric in the B-stage oven. The A-stage, or resin varnish, was painted on the front and back of the fabric. Paper clips were unfolded and inserted into the both holes of one wood support. The resin-saturated fabric was hung from aluminum supports in a laboratory fume hood and allowed to drip dry for about one minute before hanging in a pre-heated (to 170° C.) forced air Blue M oven (Lab Safety Supply Inc., a unit of General Signal) for 4 minutes. The edges of the B-staged pre-preg were removed by reducing the sheet dimensions to 10 inch by 10 inch. The sheet was cut into four 5 inch by 5 inch sheets and weighed before stacking the four layers of pre-preg between two layers of Pacothane release film (Insulectro Corp.) and two steel plates (⅛ inch thick, 12 inch by 12 inch square dimensions). The laminate was formed in the hot press at 5,000 psig for 1 hour. The resulting laminate was 0.032 inches thick, contained 44 wt % resin and underwent 3 wt % resin overflow during pressing. Five 0.5 inch wide coupons were cut from the laminate using a diamond saw, and the coupon edges were smoothed with sandpaper. The flammability of the coupons was screened by ASTM D3801-06 using an Atlas UL-94 burn chamber, resulting in a V-0 rating with 13 seconds total burn time for the two ignitions on all five coupons.

The invention described and claimed herein is not to be limited in scope by the specific examples and embodiments herein disclosed, since these examples and embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

What is claimed is:

1. A polymer composition comprising
a) a thermoplastic or thermosetting flammable polymer and
b) a brominated aromatic polymer composition has the formula:
C₆H₍₅₋ₓ₎BrₓCH₂CH₂(C₆H₍₅₋ₓ₎BrₓCHCH₂—)ₙCH₂C₆H₍₅₋ₓ₎Brₓ
wherein C₆H₍₅₋ₓ₎Brₓ is a brominated phenyl group, n is an average number in the range of about 2.9 to about 4.4, wherein each x is the same or different and is a whole number in the range of 3 to 5, and the average number of all of the x's in the brominated aromatic polymer composition being in the range of about 3.50 to about 3.80.

2. The polymer composition of claim 1, wherein the distribution of the brominated aromatic polymer composition is further characterized by having an M_{w} in the range of about 1610 to about 4320, an Mₙ in the range of about 1310 to about 3020, an M_{z} in the range of about 2060 to about 6670, and a polydispersity in the range of about 1.1 to about 1.65.

3. The polymer composition of claim 1, wherein the distribution of the brominated aromatic polymer composition is characterized by having an M_{w} in the range of about 2440 to about 2950, an Mₙ in the range of about 1880 to about 2360, an M_{z} in the range of about 3120 to about 4400, and a polydispersity in the range of about 1.2 to about 1.35.

4. The polymer composition of claim 1, wherein the polymer composition has
(a) a TGA weight loss of 5% occurring at a temperature greater than 350° C.,
(b) a thermal HBr value at 300° C. below the detection limit of 50 ppm and no more than about 200 ppm,
(c) a thermal HBr value at 320° C. in the range of about 100 ppm to about 900 ppm,
(d) an ASTM D 1925 Yellowness Index in the range of about 1 to about 4,
(e) a ΔE value in the Hunter Solution Color Value Test in the range of 0 to about 1, or
(f) a glass transition temperature in the range of about 111° C. to about 125° C.

5. The polymer composition of claim 1, wherein the thermoplastic or thermosetting flammable polymer is ethylene-vinyl acetate, epoxy novolac resin, polyamides, polyethylene terephthalate, polybutylene terephthalate, polyethylene or polypropylene.

6. The polymer composition of claim 5, wherein said polymer composition is formed in the form of a fiber or filament.

7. A process for preparing a fiber or filament, wherein said process comprises melt spinning the polymer composition of claim 1 or 5.
